(19) United States
(12) Patent Application Publication
(10) Pub. No.: US 2013/0177700 A1
(43) Pub. Date: Jul. 11, 2013

(54) METHOD FOR DROPPING LIQUID CRYSTAL AND METHOD FOR MANUFACTURING LIQUID CRYSTAL DISPLAY USING THE SAME

(71) Applicants: Tae Gyun KIM, Seoul (KR); Seung-Yeon CHAE, Seoul (KR); Sang Gun CHOI, Suwon-si (KR); A Ram LEE, Hwaseong-si (KR); Hyoung Sub LEE, Seoul (KR); Tae Woon CHA, Seoul (KR)

(72) Inventors: Tae Gyun KIM, Seoul (KR); Seung-Yeon CHAE, Seoul (KR); Sang Gun CHOI, Suwon-si (KR); A Ram LEE, Hwaseong-si (KR); Hyoung Sub LEE, Seoul (KR); Tae Woon CHA, Seoul (KR)

(73) Assignee: SAMSUNG DISPLAY CO., LTD., Yongin-City (KR)

(21) Appl. No.: 13/473,342

(22) Filed: May 16, 2012

(30) Foreign Application Priority Data
Jan. 5, 2012 (KR) 10-2012-0001643

(51) Int. Cl. B05D 5/06; B05D 5/12

(52) U.S. Cl. 427/58; 427/162

(57) ABSTRACT

A liquid crystal dropping method and a liquid crystal display manufacturing method using the same are disclosed. The method for dropping a liquid crystal includes dropping a liquid crystal along a plurality of liquid crystal dropping routes on a display panel where a plurality of pixels are arranged in a matrix form, wherein a relative position of a first liquid crystal dropping route passing a first pixel among the plurality of pixels with respect to the first pixel, and a relative position of a second liquid crystal dropping route passing a second pixel among the plurality of pixels with respect to the second pixel, are substantially equivalent to each other.

### CROSS-REFERENCE TO RELATED APPLICATION

This application claims priority to and the benefit of Korean Patent Application No. 10-2012-0001643 filed in the Korean Intellectual Property Office on Jan. 5, 2012, the entire contents of which are incorporated herein by reference.

### BACKGROUND OF THE INVENTION

(a) Field of the Invention

The present invention relates to a method for dropping liquid crystal and a method for manufacturing a liquid crystal display using the same.

(b) Description of the Related Art

A liquid crystal display, which is one of the most commonly used flat panel displays, includes two sheets of display panels with field generating electrodes such as a pixel electrode and a common electrode, and a liquid crystal layer interposed therebetween. The liquid crystal display generates an electric field in the liquid crystal layer by applying voltages to the field generating electrodes, and determines the direction of liquid crystal molecules of the liquid crystal layer by the electric field, thereby controlling polarization of incident light so as to display images.

In general, the two display panels of the liquid crystal display are combined with each other by a sealant which is formed in the circumferences at edges of the two panels and seals the liquid crystal materials forming the liquid crystal layer. The gap between the two panels are supported by spacers that are dispersed between the upper panel and the lower panel to maintain a cell gap.

In order to form a liquid crystal layer in the liquid crystal display, a liquid crystal dropping method is used for a display panel. For example, firstly, an alignment layer for aligning liquid crystals is formed on the opposing surfaces of the two display panels. Next, a sealant is formed in one of the two display panels so as to form an active area therein, and liquid crystals are dripped on one of the two display panels. Then, the two display panels are aligned and combined with each other in a vacuum state and the sealant is hardened to form a display panel assembly.

In order to uniformly drop accurate amounts of liquid crystals, the liquid crystals are dropped one drop by one drop. This method is called a one-drop method. When the two displays on one of which the liquid crystals are dropped by this one-drop method are combined with each other, a liquid crystal drop is spread out from the liquid crystal drop area. In this case, various causes such as the state of a under-layer on which the liquid crystal drop is dropped, for example, the degree of damage or existence of an alignment layer, the surface elevation and morphology of the surface of the display panel, or variation and contamination of a liquid crystal material at an edge of the liquid crystal drop may cause non-uniformity of the liquid crystal layer according to positions and stain originating from the liquid crystal dropping.

In particular, characteristics of an under-layer on which a liquid crystal drop is dropped may cause a difference in pretilt angles of the liquid crystal molecules included in the liquid crystal drop, and accordingly light leakage due to a stain originated from the liquid crystal dropping may occur when displaying an image.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide a method for dropping a liquid crystal without stain originated from liquid crystal dropping, and a method for manufacturing a liquid crystal display using the same.

Additional features of the invention will be set forth in the description which follows, and in part will be apparent from the description, or may be learned by practice of the invention.

An exemplary embodiment of the present invention discloses a method for dropping a liquid crystal comprising dropping a liquid crystal along a plurality of liquid crystal dropping routes on a display panel where a plurality of pixels are arranged in a matrix form. A relative position of a first liquid crystal dropping route that passes a first pixel among the plurality of pixels with respect to the first pixel, and a relative position of the first liquid crystal dropping route that passes a second pixel among the plurality of pixels with respect to the second pixel, are substantially equivalent to each other.

An exemplary embodiment of the present invention discloses a method for manufacturing a liquid crystal display comprising preparing two display panels comprising a plurality of pixels arranged in a matrix form; and dropping liquid crystals along a plurality of liquid crystal dropping routes on one of the two display panels A relative position of a first liquid crystal dropping route that passes a first pixel among the plurality of pixels with respect to the first pixel, and a relative position of a first liquid crystal dropping route that passes a second pixel among the plurality of pixels with respect to the second pixel, are substantially equivalent to each other.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an example of a method for dropping liquid crystals on a display panel of a liquid crystal display according to an exemplary embodiment of the present invention.

FIG. 2 shows one pixel of a liquid crystal display and a dropped liquid crystal drop according to the exemplary embodiment of the present invention.

FIG. 3 shows an example of a method for dropping liquid crystals on a display panel of a liquid crystal display according to an exemplary embodiment of the present invention.

FIG. 4 is a cross-sectional view of a drop of liquid crystal dropped on a display panel of the liquid crystal display according to an exemplary embodiment of the present invention.

FIG. 5 is an example illustrating a method for dropping liquid crystals on a display panel according to an exemplary embodiment of the present invention.

FIG. 6 is an example illustrating a method for dropping liquid crystals on a display panel according to an exemplary embodiment of the present invention.

FIG. 7 is an example illustrating a method for dropping liquid crystals on a display panel according to an exemplary embodiment of the present invention.

FIG. 8 is a partial cross-sectional view of a display panel of a liquid crystal display according to an exemplary embodiment of the present invention.

FIG. 9 is a partial cross-sectional view of a display panel of a liquid crystal display according to an exemplary embodiment of the present invention.

FIG. 10 is a cross-sectional view of a display panel of a liquid crystal display, on which a liquid crystal is dropped.

FIG. 11 is a cross-sectional view of a display panel of a liquid crystal display on which a liquid crystal is dropped.

FIG. 12 is an example illustrating a method for dropping liquid crystals on a display panel of a liquid crystal display according to an exemplary embodiment of the present invention.

FIG. 13 is an example illustrating a method for dropping liquid crystals on a display panel of a liquid crystal display according to an exemplary embodiment of the present invention.

FIG. 14 exemplarily shows a pretilt angle of a liquid crystal molecule in a case that the liquid crystal is dropped at the periphery region of a contact hole of a display panel in a liquid crystal display according to an exemplary embodiment of the present invention and a case that the liquid crystal is dropped at a region away from the periphery region of the contact hole.

FIG. 15 is an example illustrating a method for dropping liquid crystals on a display panel of a liquid crystal display according to an exemplary embodiment of the present invention.

FIG. 16 is an example illustrating a method for dropping liquid crystals on a display panel of a liquid crystal display according to an exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

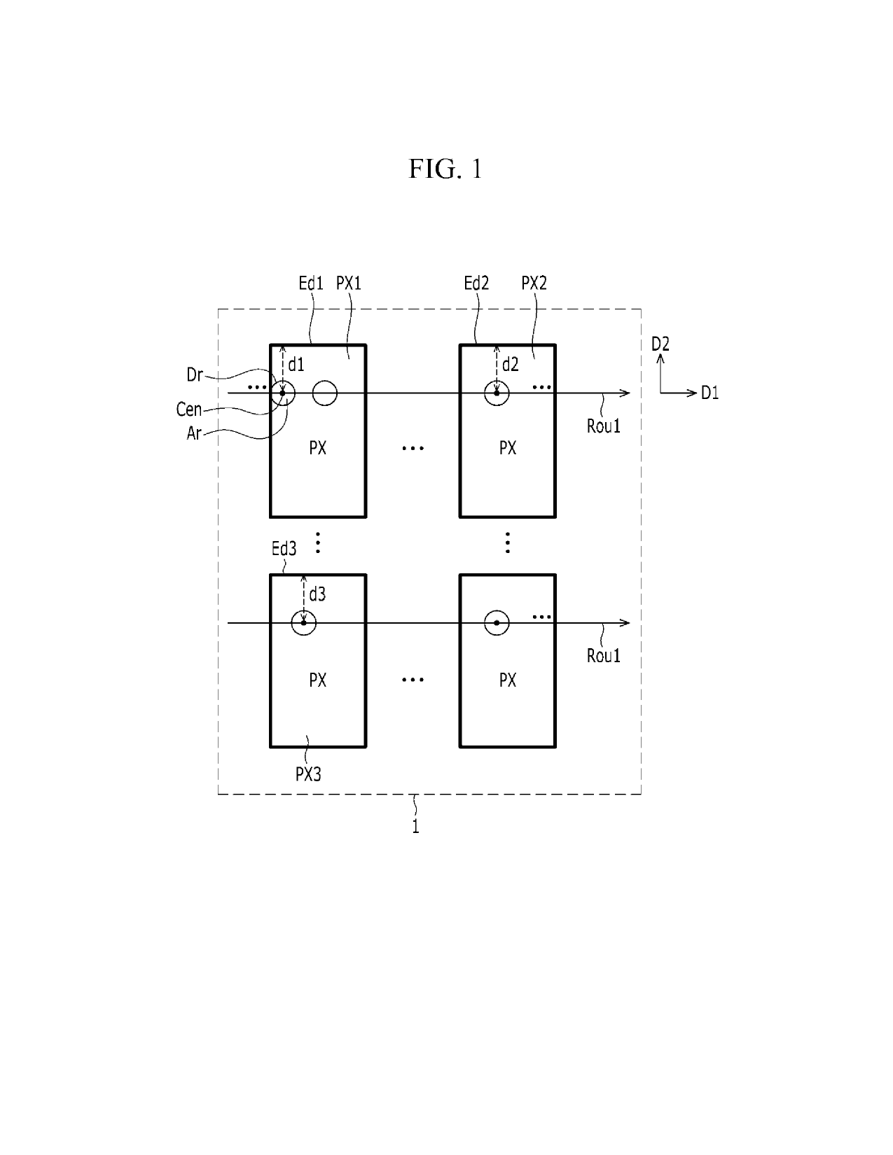

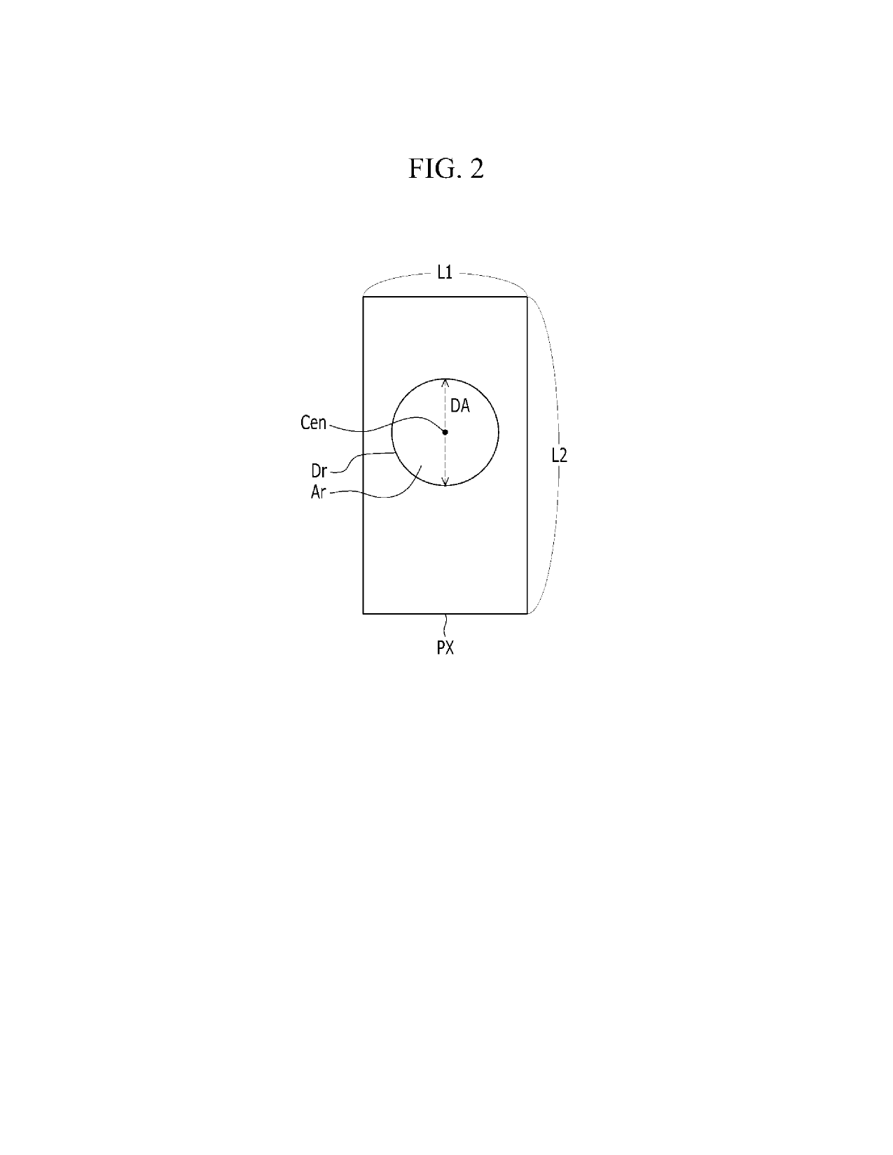

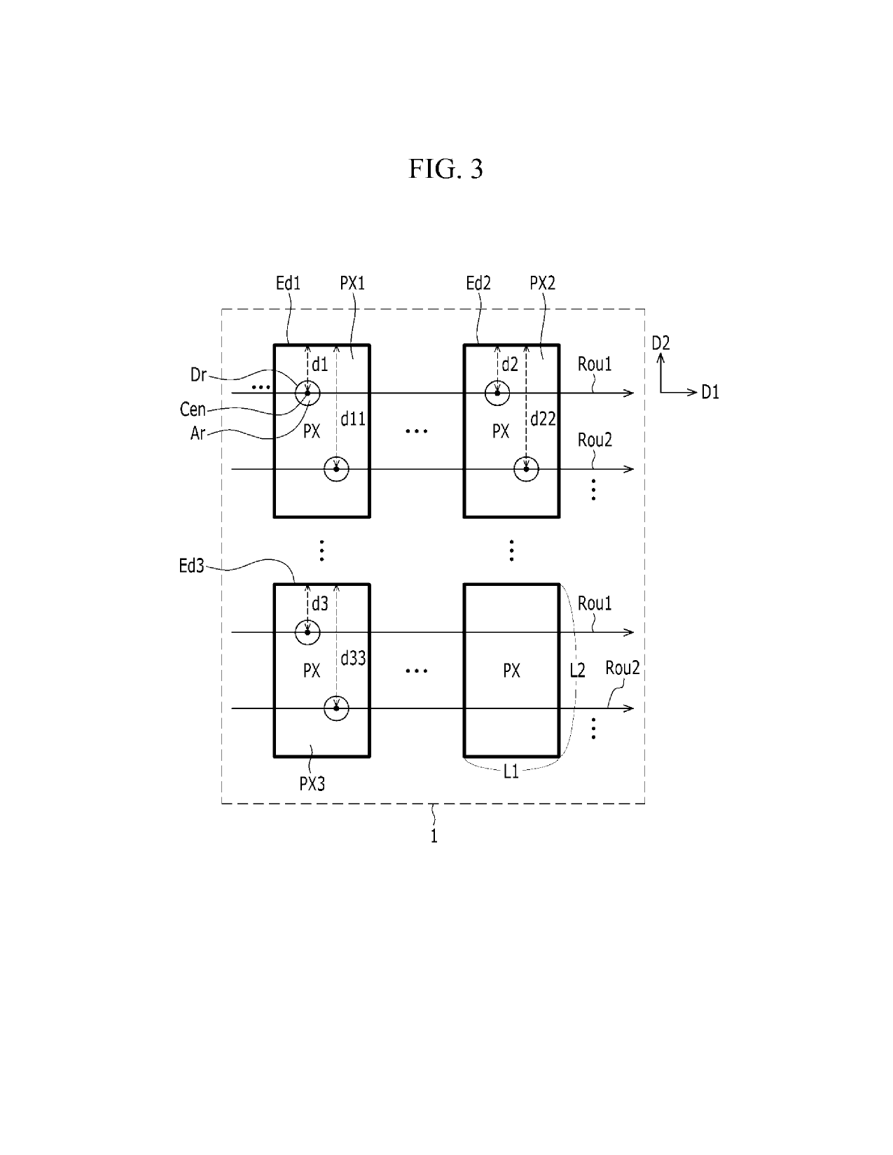

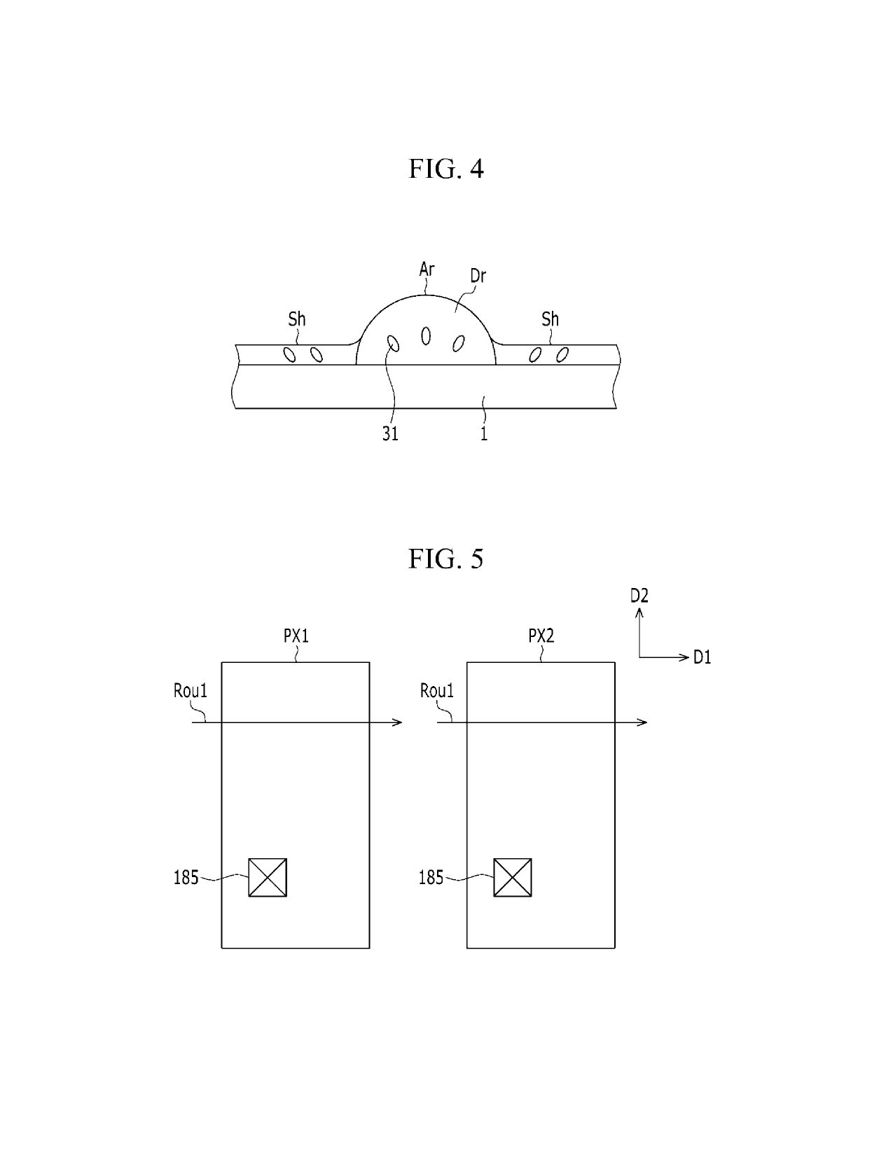

First, referring to FIG. 1, FIG. 2, FIG. 3 and FIG. 4, a liquid crystal display, a manufacturing process thereof, and in particular, a liquid crystal drop method according to an exemplary embodiment of the present invention will be described.

FIG. 1 shows an example of a method for dropping liquid crystal on a display panel of a liquid crystal display according to an exemplary embodiment of the present invention, FIG. 2 shows one pixel of a liquid crystal display and a dropped liquid crystal drop according to the exemplary embodiment of the present invention, FIG. 3 shows an example of a method for dropping liquid crystal on a display panel of a liquid crystal display according to an exemplary embodiment of the present invention, and FIG. 4 is a cross-sectional view of a drop of liquid crystal dropped on a display panel of the liquid crystal display according to an exemplary embodiment of the present invention.

A manufacturing method of a liquid crystal display according to an exemplary embodiment of the present invention will be briefly described. First, two display panels to be combined with each other are prepared. One of the two display panels may be provided with thin film transistors and several electric elements (e.g., a pixel electrode) connected to the thin film transistors, and the other one may be provided with a color filter, a light blocking member, and the like. However, it is not restrictive thereto, and the color filter or the light blocking member may be formed in the display panel where the thin film transistor is formed.

In the two display panels, as shown in FIG. 1 and FIG. 3, a plurality of pixels PX are arranged in a matrix form.

A pixel PX is a unit for a liquid crystal display to display an image. In the exemplary embodiment of the present invention, the pixel PX may be defined as a light transmissive area or an opening area where light can transmit without being blocked by a light blocking member, or may be defined as an area where a pixel electrode receiving a data voltage for an input image data is formed.

Each pixel may include a thin film transistor for transmitting a data voltage, a pixel electrode connected with the thin film transistor and receiving the data voltage, and a contact portion where the thin film transistor and the pixel electrode are connected to each other.

In order to realize color display, each of the pixels PX may uniquely display one of the primary colors (spatial division), or each pixel PX may display the primary colors alternately with time (temporal division), such that a desired color may be displayed by a spatial or temporal sum of the primary colors. Examples of the primary colors include three primary colors of red, green and blue. In case of the spatial division, each pixel PX may be provided with a color filter (not shown) displaying one of the primary colors in one of the two display panels. In the exemplary embodiment of FIG. 1, each filter may be elongated along the plurality of pixels PX arranged in a column direction, that is, a second direction D2.

As shown in FIG. 1, FIG. 2, and FIG. 3, a length L1 in a row direction of each pixel PX, that is, a length in the first direction D1 may be shorter than a length L2 in the column direction, that is, in the second direction D2, but it is not limited thereto.

Alignment layers (not shown) may be coated on inner sides of the two display panels facing each other. When the alignment layer is coated, the alignment layer may be a horizontal alignment layer or a vertical alignment layer.

Next, a sealant (not shown) is formed on one of the two display panels. The sealant couples the two display panels, and seals liquid crystal to be dropped in an area surrounded by the sealant.

Next, as shown in FIG. 1 and FIG. 3, liquid crystal is dropped on one display panel 1 among the two display panels using the liquid crystal drop device to form a plurality of liquid crystal dots Dr.

Referring to FIG. 2, each liquid crystal dot Dr includes a liquid crystal drop area Ar in which the dropped liquid crystal is located and a center point Cen of the liquid crystal drop area Ar. A cross-section of liquid crystal drop area Ar may substantially have a circular shape.

In addition, a diameter DA of the liquid crystal dot Dr may be less than the row directional length L1 or the column directional length L2 of each pixel PX. That is, a diameter DA of one liquid crystal dot Dr may be less than a longest length of a pixel PX. The size of the liquid crystal dot Dr may vary according to one drop amount of liquid crystal. For example, the one drop amount of liquid crystal may be several nanograms to several milligrams, and this value may be changed according to a process condition.

In this case, the liquid crystal dropping device may drop liquid crystals while moving along constant directions, which are called liquid crystal dropping routes Rou1 and Rou2. That is, a center point Cen of each liquid crystal dot Dr may be disposed on the liquid crystal dropping route Rou1. For the pixels arranged in the matrix form, one liquid crystal dropping route Rou1 may pass per a pixel row, or one liquid crystal dropping route Rou1 may pass per a plurality of pixel rows, as shown in FIG. 1. Alternatively and as shown in FIG. 3, a plurality of liquid crystal dropping routes may pass per a pixel row. FIG. 1 illustrates a case that one liquid crystal dropping route Rou1 passes per a pixel row, and FIG. 3 illustrates a case that two liquid crystal dropping routes Rou1 and Rou2 pass per a pixel row.

Referring to FIG. 1 and FIG. 3, the relative positions of the liquid crystal drop routes Rou1 and Rou2 respectively passing at least two pixels are substantially the same with respect to the respective at least two pixels PX.

In further detail, when an edge Ed1 of a first pixel PX1 and an edge Ed2 of a second pixel PX2 correspond to each other, and a distances d1 between the edge Ed1 and the liquid crystal dropping route Rou1 passing the first pixel PX1 and a distance between the edge Ed2 and the liquid crystal dropping route Rou1 passing the second pixel PX2 may be substantially equivalent to each other. Here, the edges Ed1 and Ed2 of the pixels PX1 and PX2 may be various edges corresponding to each other among the edges of the pixels PX1 and PX2, and they are not limited to the edges shown in the drawings. Further, the first pixel PX1 and the second pixel PX2 are illustrated to be located in the same pixel row, but the disclosure is not limited thereto. That is, the distance d1 between an edge Ed1 of the first pixel PX1 and the liquid crystal dropping route Rou1 passing the first pixel PX1 and the distance d3 between the corresponding edge Ed3 of the third pixel PX3 and the liquid crystal dropping route Rou1 passing the third pixel PX3 may be substantially equivalent to each other even when the first pixel PX1 and the third pixel PX3 are not disposed in the same pixel row and the edges Ed1 and Ed3 of the pixels PX1 and PX3 correspond to each other. FIG. 1 illustrates that the first pixel PX1 and the third pixel PX3 are disposed in the same pixel column, but it is not limited thereto, and they may be disposed in different pixel rows or different pixel columns.

Further, referring to FIG. 3, one or more liquid crystal dropping routes Rou2 may further pass each pixel row in addition to the first liquid crystal dropping route Rou1. In this case, the distances d11 and d22 between the corresponding edges Ed1 and Ed2 of the first and second pixels PX1 and PX2 and the liquid crystal dropping routes Rou2 passing the respective pixels PX1 and PX2 may be substantially equivalent to each other. In addition, the distances d11 and d33 between the corresponding edges Ed1 and Ed3 of the first and third pixels PX1 and PX3 and the respective liquid crystal dropping routes Rou2 passing the respective pixels PX1 and PX3 may be substantially equivalent to each other. In FIG. 3, the first pixel PX1, the second pixel PX2, or the third pixel PX3 may be pixels PX that are different from each other among the plurality of pixels PX.

If the relative positions with respect to two respective pixels PX of the liquid crystal dropping routes Rou1 passing the two respective pixels PX are substantially equivalent to each other, it can be assumed that the elevation and morphology of the surfaces of the display panel 1 which the liquid crystal dot Dr contacts or the state of the alignment material of the alignment layers of different pixels are substantially identical with each other if the plurality of pixels PX have substantially the same structure. Thus, for different pixels which the liquid crystal dropping route Rou1 passes, the influences of the elevation and morphology of the under-layer on which the liquid crystal dot Dr is formed or the state of the alignment material for an inclination angle of the liquid crystal molecule 31 included in the liquid crystal dot Dr with respect to the surface of the display panel 1, that is, a pretilt angle of the liquid crystal molecule 31, may be substantially equivalent to each other. Therefore, the pretilt angles of the liquid crystal molecules 31 in the liquid crystal dots Dr respectively dropped on different pixels which the liquid crystal dropping routes Rou1 and Rou2 pass may be substantially equivalent to each other for the respective pixels PX, and accordingly, display deterioration such as light leakage and stain due to non-uniformity of the pretilt angles of the liquid crystal molecules 31 can be reduced.

In particular, referring to FIG. 4, when the liquid crystal dots Dr are formed and then the two display panels are combined with each other, the liquid crystal material is spread out from the liquid crystal drop area Ar such that a liquid crystal spread area Sh is formed. The pretilt angles of the liquid crystal molecules located not only in the liquid crystal drop area Ar but also in the liquid crystal spread area Sh may be uniform in the respective pixels PX according to the present exemplary embodiment.

In the next process of the manufacturing method of the liquid crystal display, the display panel 1 on which the liquid crystal is dropped and the other display panel are attached to each other, and then the sealant is hardened. In this case, a thermal curing process for the sealant may be included. The dropped liquid crystal may experience phase transition and the diffusibility of the liquid crystals can be improved.

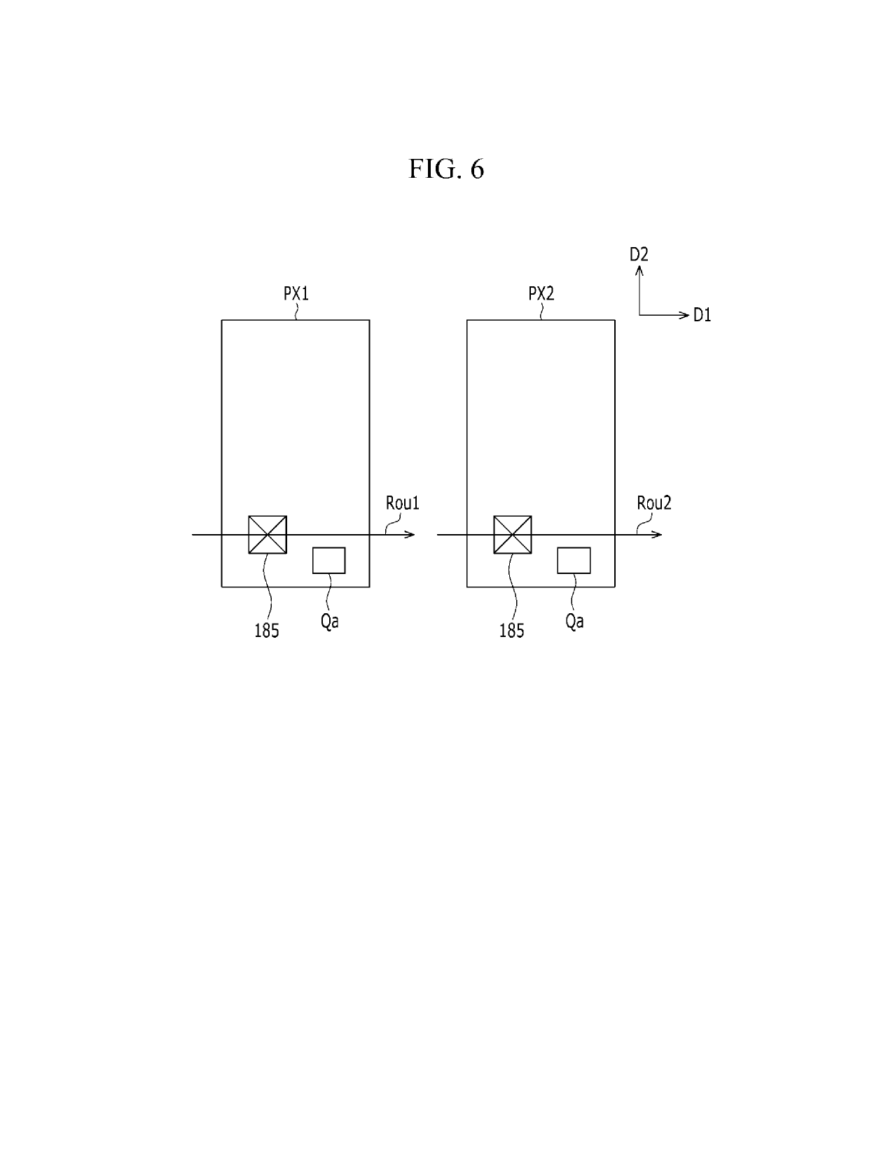

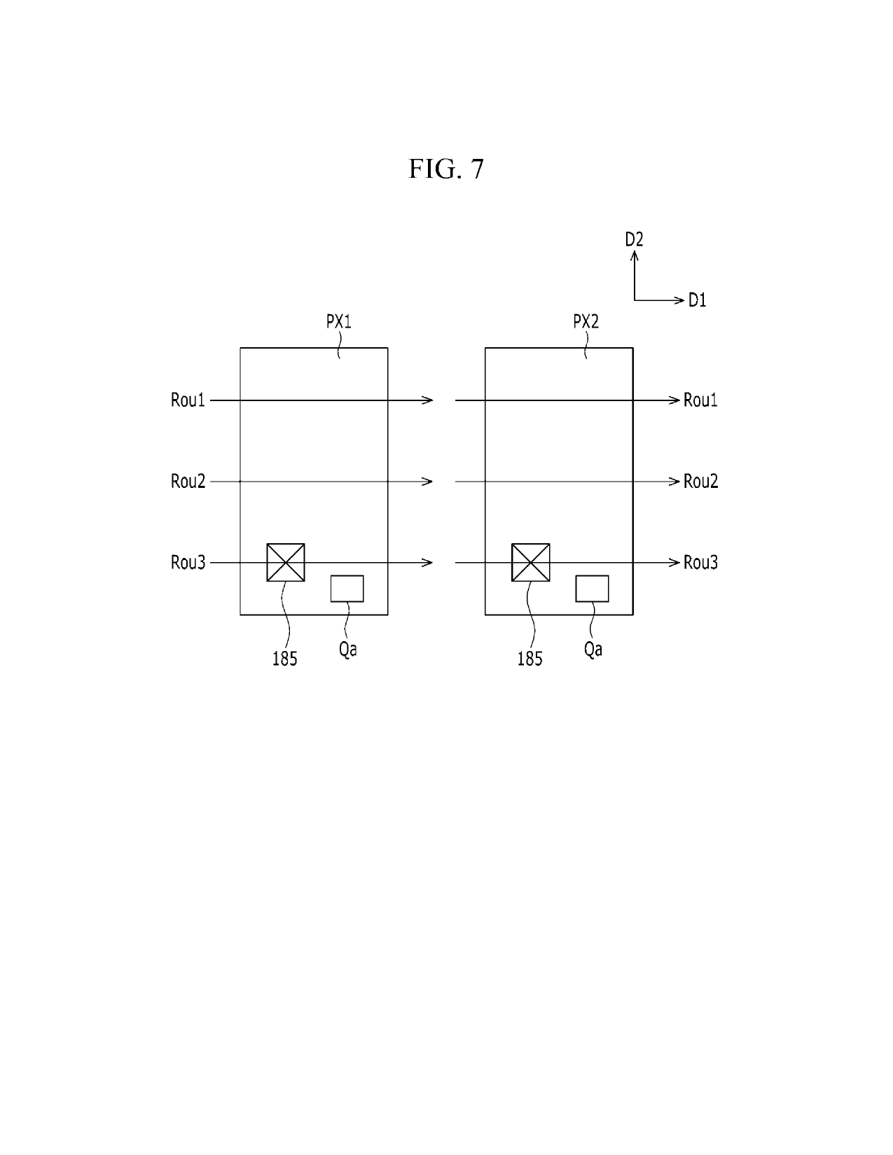

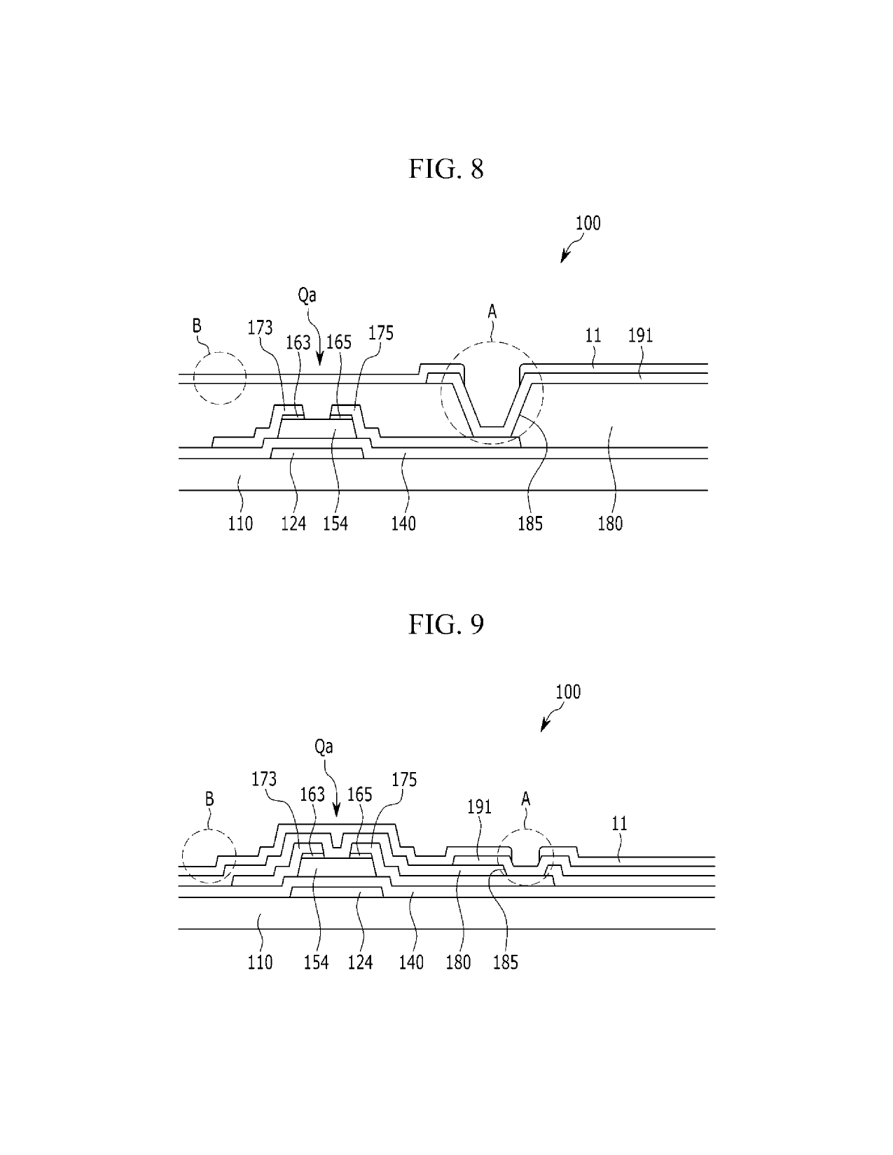

Then, referring to FIG. 5, FIG. 6, FIG. 7, FIG. 8, and FIG. 9, a liquid crystal display, a manufacturing method thereof, and in particular, a liquid crystal drop method according to an exemplary embodiment of the present invention will be described. The same constituent elements as the exemplary embodiment described above are designated to like reference numerals and like description is omitted.

FIG. 5 illustrates an example of a method for dropping a liquid crystal to a display panel of a liquid crystal display according to an exemplary embodiment of the present invention, FIG. 6 illustrates an example of a method for dropping a liquid crystal to a display panel of a liquid crystal display according to an exemplary embodiment of the present invention, FIG. 7 illustrates an example of a method for dropping a liquid crystal to a display panel of a liquid crystal display according to an exemplary embodiment of the present invention, FIG. 8 is a partial cross-sectional view of a display panel of a liquid crystal display according to an exemplary embodiment of the present invention, and FIG. 9 is a partial cross-sectional view of a display panel of a liquid crystal display according to an exemplary embodiment of the present invention.

Referring to FIG. 5 to FIG. 9, a manufacturing method of a liquid crystal display according to an exemplary embodiment of the present invention includes preparing two display panels to be attached to each other. The two display panels are almost equivalent to the display panel described in the above stated exemplary embodiment. The two display panels of the present exemplary embodiment include a thin film transistor array panel 100 where a plurality of thin film transistors are formed.

Next, liquid crystals are dropped on one of the two display panels using a liquid crystal dropping device so as to form a plurality of liquid crystal dots Dr. In this case, the liquid crystals may be dropped on a thin film transistor array panel.

Referring to FIG. 8 and FIG. 9, in the thin film transistor array panel, a plurality of gate electrodes 124 are disposed on an insulation substrate 110, and a gate insulation layer 140 is disposed on the plurality of gate electrode 124. On the gate insulating layer 140, a plurality of semiconductors 154 are disposed. Each semiconductor 154 is disposed on the gate electrode 124. On each semiconductor 154, a pair of ohmic contact islands 163 and 165 are disposed. A plurality of source electrodes 173 and a plurality of drain electrodes 175 are disposed on the ohmic contact islands 163 and 165 and the gate insulating layer 140. The source electrode 173 may transmit a data signal and faces a drain electrode 175 with respect to a gate electrode 124. The gate electrode 124, the source electrode 173, and the drain electrode 175 form a thin film transistor Qa with the semiconductor 154, and a channel of the thin film transistor Qa is formed in the semiconductor 154 between the source electrode 173 and the drain electrode 175.

A passivation layer 180 is disposed on the source electrode 173, the drain electrode 175, and an exposed portion of the semiconductor 154. The passivation layer 180 may be made of an inorganic insulator or an organic insulator. As shown in FIG. 8, the surface of the passivation layer 180 may be flat or, as shown in FIG. 9, it may not be flat. A contact hole 185 that exposes the drain electrode 175 is formed in the passivation layer 180.

A plurality of pixel electrodes 191 are disposed on the passivation layer 180. Each pixel electrode 191 is connected with the drain electrode 175 through the contact hole 185 and receives a data voltage from the drain electrode 175.

An alignment layer 11 may be disposed on the pixel electrode 191 and the passivation layer 180.

The configuration, morphology and level of the surface of the thin film transistor array panel 100 and the state of the alignment layer 11 will now be described. As shown in FIG. 8, when the surface of the passivation layer 180 is quite flat, a portion of the insulation layer is removed in the same way as the contact hole 185 is formed, and thus most of the surface can be flat, excluding a portion having a large step difference. However, since the passivation layer 180 is removed at a portion where the contact hole 185 is disposed, the surface of the thin film transistor array panel 100 where the contact hole 185 is formed has a relatively large step difference. Thus, when the alignment layer 11 is coated, the alignment layer 11 may not be fully coated on a portion on the thin film transistor array panel 100 where the contact hole 185 is formed. In addition to the portion where the contact hole 185 is formed, the alignment layer 11 may not be coated uniformly on a portion having a large step difference due to a deposition structure of the thin film transistor array panel 100.

In addition, as in the exemplary embodiment shown in FIG. 9, even when the thickness of the passivation layer 180 is relatively not thick, the surface of the thin film transistor array panel 100 where the contact hole 185 is disposed has a relatively large step difference, and accordingly, at least a part of the alignment layer 11 may not be coated on an area where the contact hole 185 is formed. Further, in the thin film transistor array panel 100, the surface of a portion where an electric element having a complicate layer structure like the thin film transistor Qa is formed may not be flat.

As described, according to the layer structure of the thin film transistor array panel 100, the surface of the thin film transistor array panel 100 has a difference in elevation, and the alignment layer 11 may have a different state according to the positions.

Next, a sealant is formed on one of the two display panels to be attached to each other, and liquid crystals are dropped on one of the two display panels using a liquid crystal dropping method to form a plurality of liquid crystal dots Dr.

As shown in FIG. 5 and FIG. 6, one liquid dropping route Rou1 may pass per a respective pixel PX1 and PX2, or one liquid crystal dropping route Rou1 may pass per a plurality of pixel rows. Further, as shown in FIG. 7, a plurality of liquid crystal dropping routes Rou1, Rou2, and Rou3 may pass per pixels PX1 and PX2. FIG. 7 illustrates that three liquid crystal dropping route Rou1, Rou2, and Rou3 pass each of the pixels PX1 and PX2, but the number of liquid crystal dropping routes may be two or more, and not limited thereto. In the exemplary embodiments of FIG. 5, FIG. 6, and FIG. 7, the liquid crystal dropping routes Rou1, Rou2, and Rou3 are arranged along a row direction, but it is not limited thereto, but they may be arranged along a column direction.

In the present exemplary embodiment, relative positions of the liquid crystal drop routes Roue1, Roue2, and Roue3 passing at least two pixels PX with respect to the at least two pixels PX are substantially equivalent to each other.

In further detail, referring to FIG. 5, the elevation, morphology, or state of the surface of the thin film transistor array panel 100 respectively corresponding to two different pixels PX1 and PX2 through which the liquid crystal dropping route Rou1 passes may be substantially equivalent to each other.

For example, referring to FIG. 5, when the liquid crystal dropping route Rou1 passing through the first pixel PX1 passes a region other than a region where the contact hole 185 or the thin film transistor Qa is located, the liquid crystal dropping route Rou1 passing through the second pixel PX2 passes a region other than a region where the contact hole 185 or the thin film transistor Qa is located. That is, the step differences of the surface of the thin film transistor array panel at the positions where the liquid crystal dropping route Rou1 passes the two different pixels PX1 and PX2 may be insignificant and substantially equivalent to each other.

Referring to FIG. 6, when liquid crystal dropping route Rou1 passing through the first pixel PX1 passes the contact hole 185, the liquid crystal dropping route Rou2 passing through the second pixel PX2 also passes the contact hole 185. When the liquid crystal dropping route Rou1 passing through the first pixel PX1 passes the thin film transistor Qa, the liquid crystal dropping route Rou2 passing through the second pixel PX2 may also pass the thin film transistor Qa. That is, the step differences of the surface of the thin film transistor array panel 100 in the portions where the liquid crystal dropping route Rou1 and the liquid crystal dropping route Rou2 pass the two different pixels PX1 and PX2 may be equally, and significantly large.

Referring to FIG. 7, when a plurality of liquid crystal dropping routes Rou1, Rou2, and Rou3 exist for one pixel PX1, PX2, or PX3, the number of the liquid crystal dropping routes passing through the respective pixels PX1, PX2, and PX3 may be equivalent to each other. In addition, for each pixel PX1 and PX2, the number of liquid crystal dropping routes Rou1 and Rou2 passing a region where the step difference of the thin film transistor array panel 100 is insignificant may be equivalent to each other, and the number of liquid crystal dropping route Rou3 passing through a region where the step difference of the thin film transistor array panel 100 is relatively significant, such as the contact hole 185 may be equivalent to each other.

As described, the step difference or the surface morphology of the surface or the state of the alignment layer 11 of the thin film transistor array panel 100 which the liquid crystal dropping routes Rou1, Rou2, and Rou3 pass is substantially equivalent to each other for different pixels PX1 and PX2 according to an exemplary embodiment of the present invention. In this case, even when the liquid crystal is dropped on the other display panel facing the thin film transistor array panel 100, the surface step difference, the surface morphology, or the state of the alignment layer 11 of the thin film transistor array panel 100 facing the liquid crystal dropping routes Rou1, Rou2, and Rou3 may be substantially equivalent to each other for different pixels. Thus, the pretilt angles of the liquid crystal molecules 31 of the liquid crystal dots Dr or the liquid crystal spread areas Sh may be formed uniformly by forming the liquid crystal dots Dr along the liquid crystal dropping routes Rou1, Rou2, and Rou3 for different pixels.

This will be described in further detail with reference to FIG. 5 to FIG. 10 and FIG. 10 to FIG. 14.

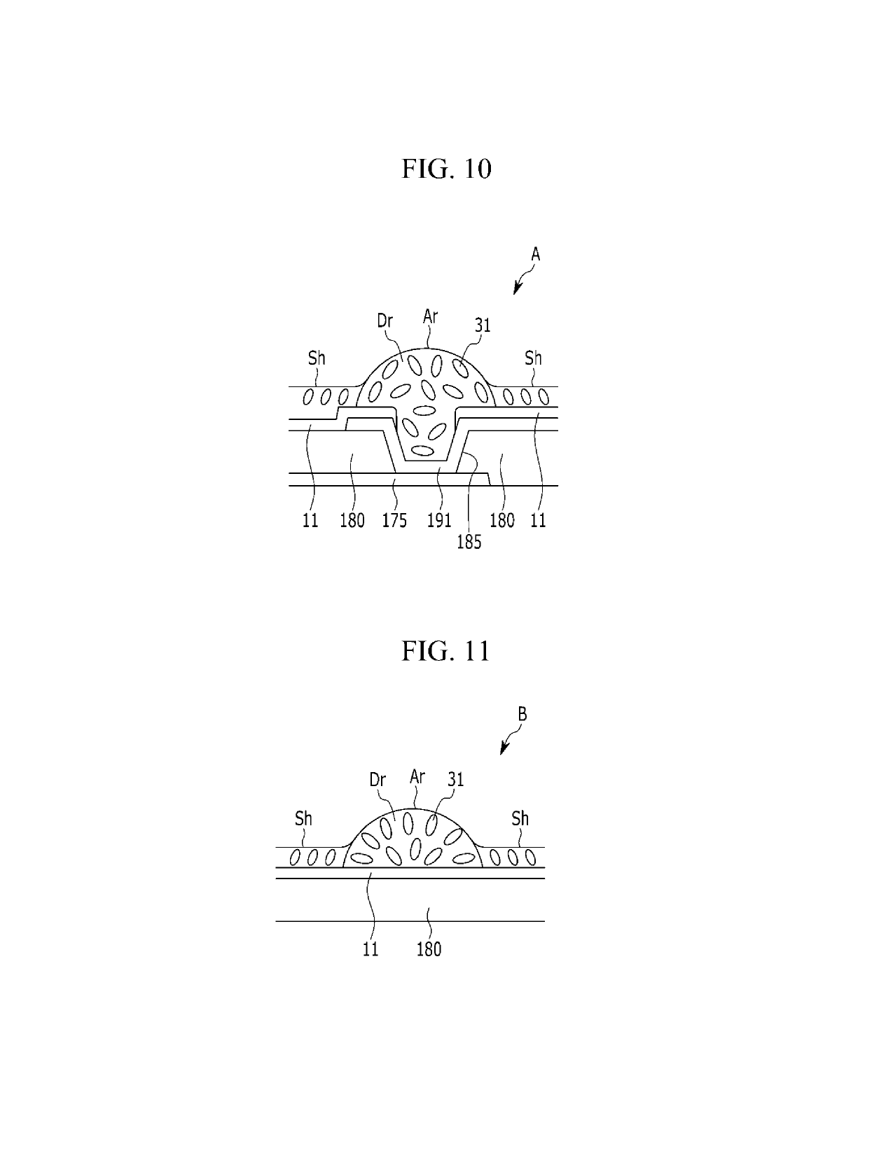

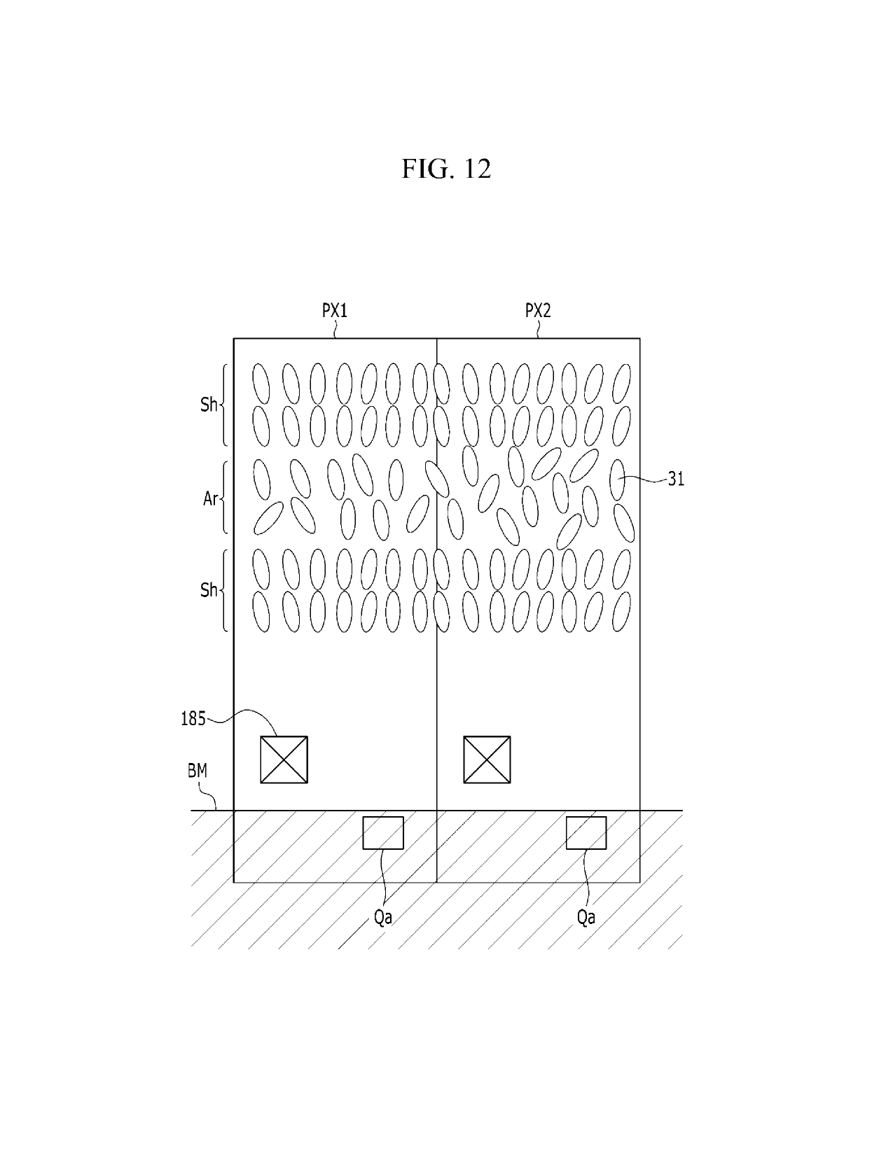

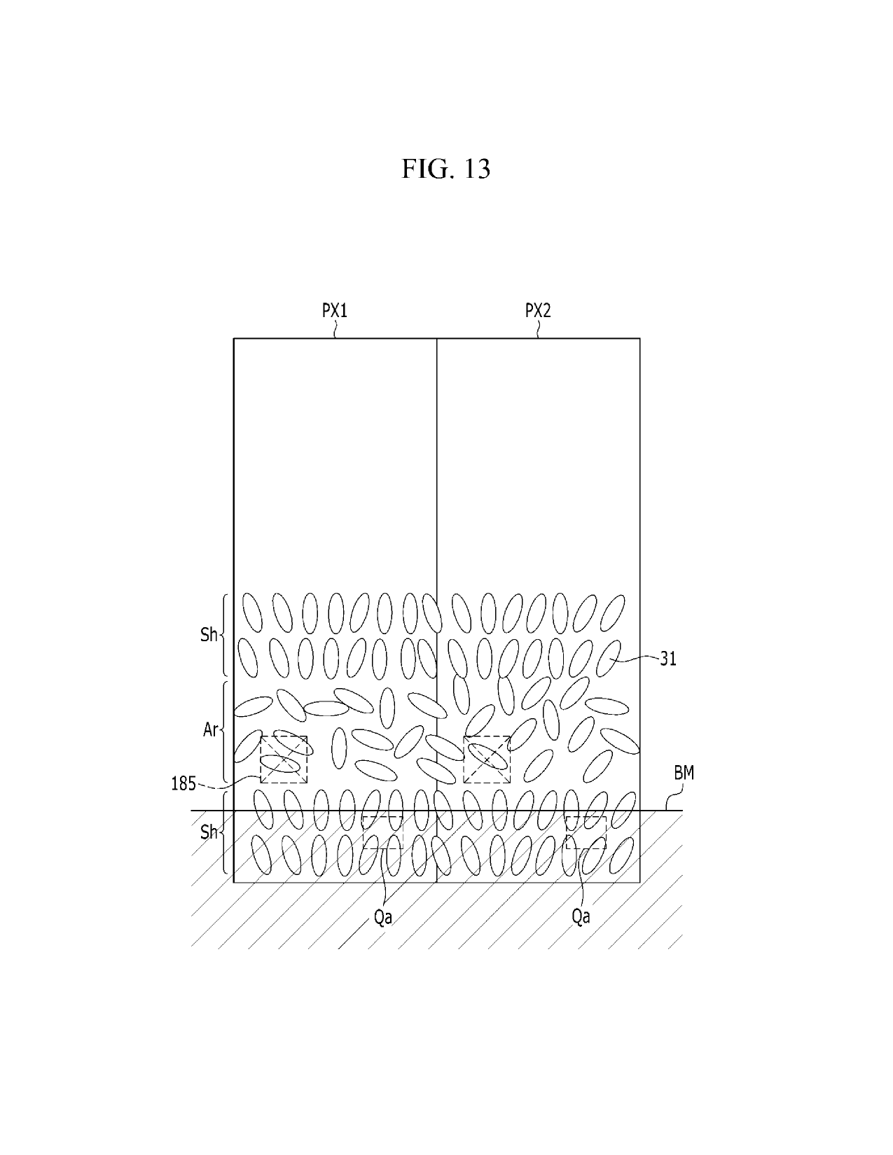

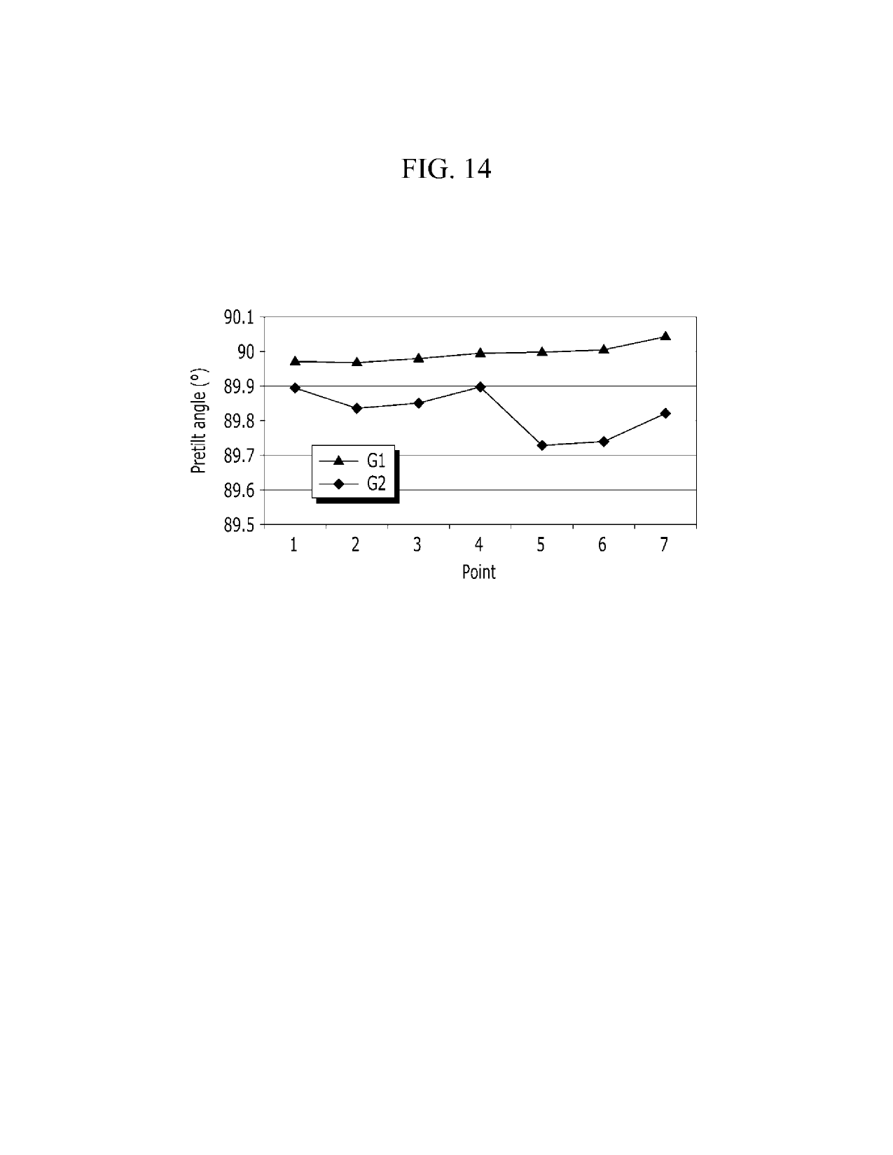

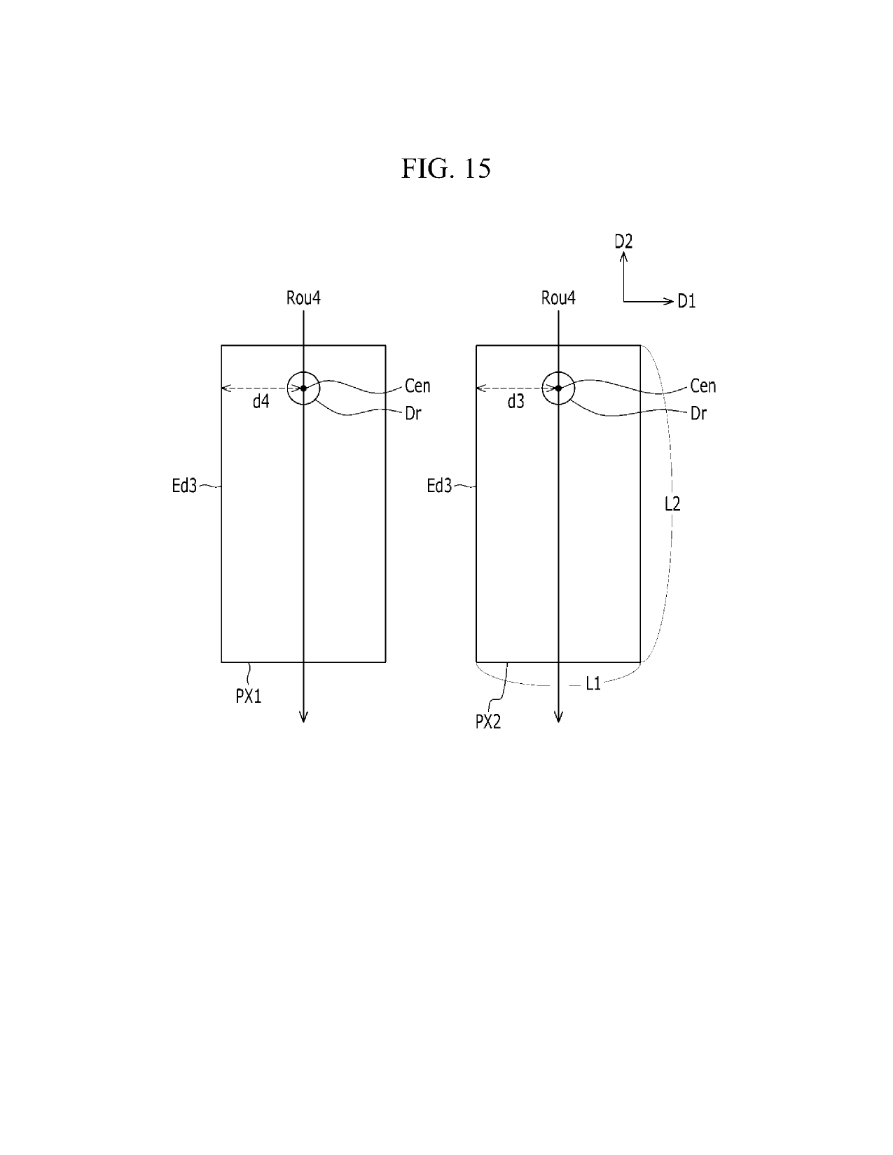

FIG. 10 is a cross-sectional view of a first region of the display panel of a liquid crystal display on which a liquid crystal is dropped, FIG. 11 is a cross-sectional view of a second region of the display panel of a liquid crystal display on which a liquid crystal is dropped, FIG. 12 shows the configuration of the liquid crystals obtained as a result of a method for dropping liquid crystals on a display panel of a liquid crystal display according to an exemplary embodiment of the present invention, FIG. 13 shows the configuration of the liquid crystals obtained as a result of another method for dropping liquid crystals on a display panel of a liquid crystal display according to an exemplary embodiment of the present invention, and FIG. 14 exemplarily shows the pretilt angle of liquid crystal molecules in a case that the liquid crystals are dropped at the periphery regions of a contact hole of a display panel in a liquid crystal display according to the exemplary embodiment of the present invention and a case that the liquid crystals are dropped at a region different from the periphery of the contact hole.

Referring to FIG. 10 and FIG. 11, a case that the liquid crystal dot Dr is formed in an area where the step difference of the thin film transistor array panel 100 is relatively large, such as the area “A” in FIG. 8 and FIG. 9 and a case that the liquid crystal dot Dr is formed in an area where the step difference of the thin film transistor array panel 100 is not relatively large, such as the area “B” in FIG. 8 and FIG. 9 are compared with each other. The result of the comparison shows that pretilt angles of the liquid crystal molecules 31 of the liquid crystal dropping area Ar may be different from each other depending on the state of the under-layer of the liquid crystal dot Dr (e.g., the step difference, or the state or step difference of the alignment layer 11). In addition, the pretilt angles of the liquid crystal molecules 31 in the liquid crystal spread area Sh spread out from each of the liquid crystal dropping areas Ar may be different from each other depending on a dropped area.

Likely, referring to FIG. 12, FIG. 13, and FIG. 14, a case that the liquid crystal is dropped on an area where the step difference of the thin film transistor array panel 100 is not relatively large, for example, a portion where the contact hole 185 and the thin film transistor Qa are not formed, like the area “B” in FIG. 8 and FIG. 9 and a case that the liquid crystal is dropped on an area where the step difference of the thin film transistor array panel 100 is relatively large, for example, an area where the contact hole 185 is located, like the area “A” in FIG. 8 and FIG. 9 are compared. The result of the comparison shows that the pretilt angles of the liquid crystal molecules 31 in the liquid crystal dropping area Ar and the liquid crystal spread area Sh may be different from each other. Also the comparison between FIGS. 10 and 11 shows that the pretilt angles of the liquid crystal molecules 31 when the drop is situated at the position shown in FIG. 10 are different from the pretilt angles of the liquid crystal molecules 31 when the drop is situated at the position shown in FIG. 11, both for the molecules in the liquid crystal dropping area Ar and for the molecules in the liquid spread area Sh.

Referring to FIG. 14, the graph G1 shows the pretilt angles of the liquid crystal molecules 31 in the case that the liquid crystal is dropped on points, shown on the horizontal line of FIG. 14, corresponding to the area where the contact hole 185 is not located, and the graph G2 shows the pretilt angles of the liquid crystal molecule 31 in the case that the liquid crystal is dropped on points corresponding to the area where the contact hole 185 is located. The result of the comparison of the graph G1 and the graph G2 shows that the pretilt angles of the liquid crystal molecules 31 are significantly different depending on whether the liquid crystals are dropped in the contact hole 185 or away from the contact hole 185.

Meanwhile, in FIG. 12 and FIG. 13, when the liquid crystal is dropped on an area corresponding to the thin film transistor Qa, the portion of the thin film transistor Qa may be blocked by a light blocking member BM and the like. Thus, light cannot be transmitted to the portion where the thin film transistor Qa is located, and accordingly, a stain due to the pretilt angle difference of the liquid crystal molecule 31 cannot be visible. However, when the pretilt angle difference of the liquid crystal molecule 31 occurs in an opening through which the light is transmitted in each pixel PX, the pretilt angle difference may causes light leakage or stain, thereby causing a display failure.

However, as previously described, according to the exemplary embodiment of the present invention, the relative positions of the liquid crystal drop with respect to respective pixels are substantially equivalent to each other in different pixels PX, and therefore the elevation and morphology of the lower surface of the liquid crystal dropping area Ar or the liquid crystal spread area Sh or the state of the alignment layer 11 may be substantially equivalent to each other, and pretilt angles of liquid crystal molecules 31 of different pixels PX may be substantially equivalent to each other. Accordingly, the stain or light leakage due to the liquid crystal drop can be prevented.

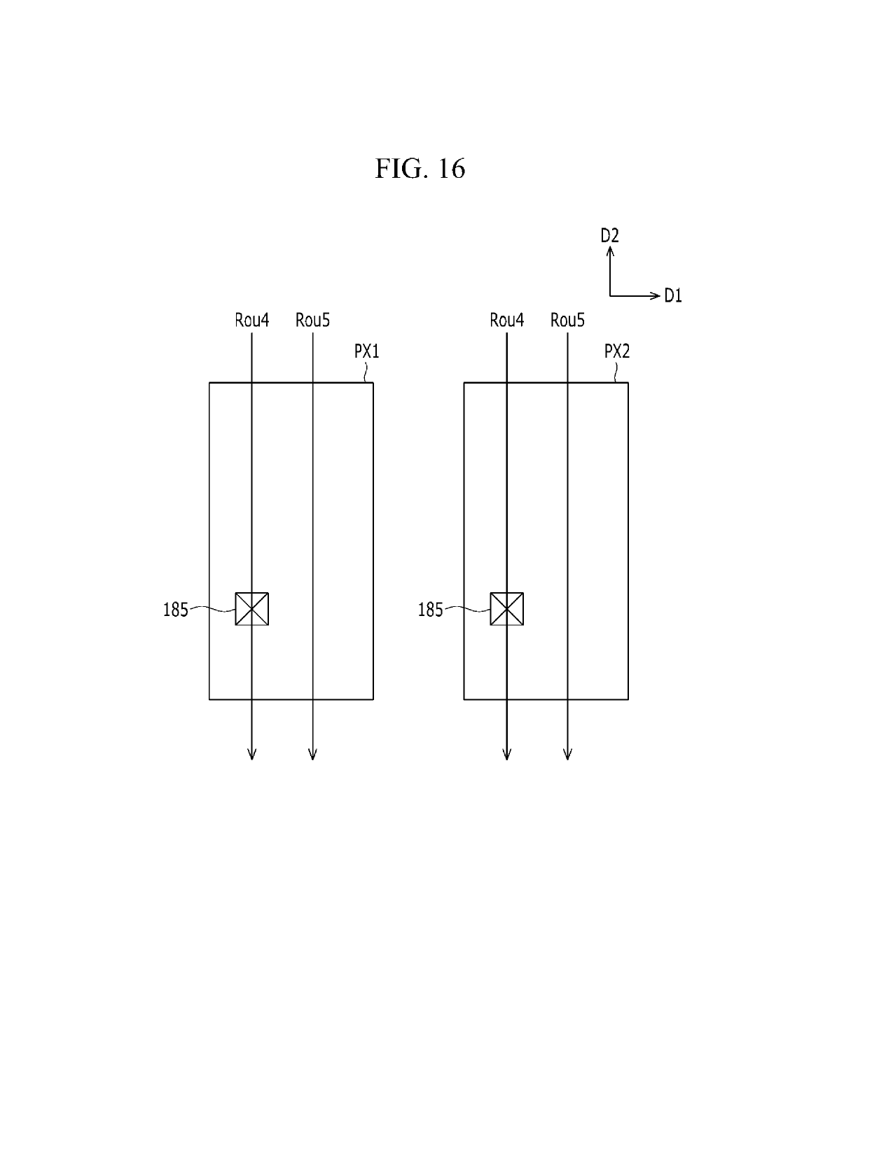

A liquid crystal dropping method according to an exemplary embodiment of the present invention will now be described with reference to FIG. 15 and FIG. 16. The same constituent elements as the exemplary embodiment described above are designated to like reference numerals and like description is omitted.

FIG. 15 is an example illustrating a method for dropping liquid crystals on a display panel of a liquid crystal display according to an exemplary embodiment of the present invention and FIG. 16 is an example illustrating a method for dropping liquid crystals on a display panel of a liquid crystal display according to an exemplary embodiment of the present invention.

Referring to FIG. 15, a liquid crystal dropping route Rou4 may be formed along a column direction. In this case, a low directional length L1 of each of the pixels PX1 and PX2 may be longer than a column directional length L2 of each of the pixels PX1 and PX2. In the present exemplary embodiment, a distance d4 between one edge Ed3 of the pixel PX1 and the liquid crystal dropping route Rou4 may be substantially equivalent to a distance d3 between one edge Ed3 of the pixel PX2 and the liquid crystal dropping route Rou4.

Further, referring to FIG. 16, two or more liquid crystal dropping routes Rou4 and Rou5 may pass the respective pixels PX1 and PX2 among the liquid crystal dropped pixels. In this case, as shown in FIG. 15, distances between the respective liquid crystal dropping routes Rou4 and Rou5 and the corresponding edges of the two pixels PX1 and PX2 may be substantially equivalent to each other for the two pixels PX1 and PX2. Further, as shown in FIG. 16, the liquid crystal dropping routes Rou4 and Rou5 corresponding to each other in the two different pixels PX1 and PX2 may pass regions of which under-layers have large step differences like the contact hole 185 or regions where the under-layers are smooth.

The exemplary embodiments described for several pixels (e.g. PX1, PX2, PX3) may be applied to all of the plurality of pixels PX.

According to the exemplary embodiments of the present invention, a stain originated from liquid crystal drop in the liquid crystal display can be removed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for dropping a liquid crystal, the method comprising:
dropping a liquid crystal along a plurality of liquid crystal dropping routes on a display panel where a plurality of pixels are arranged in a matrix form,
wherein a relative position of a first liquid crystal dropping route passing a first pixel among the plurality of pixels with respect to the first pixel, is substantially equivalent to a relative position of a second liquid crystal dropping route passing a second pixel among the plurality of pixels with respect to the second pixel.

2. The method of claim 1, wherein an edge of the first pixel and an edge of the second pixel corresponding to each other are respectively referred as a first edge and a second edge, and
a distance between the first liquid crystal dropping route and the first edge and a distance between the second liquid crystal dropping route and the second edge are substantially equivalent to each other.

3. The method of claim 2, wherein a plurality of liquid crystal dots are formed along a liquid crystal dropping route of the plurality of liquid crystal dropping routes, and
a diameter of the liquid crystal dot is less than a longest length of a pixel.

4. The method of claim 3, wherein a step difference of a surface of the display panel corresponding to the first liquid crystal dropping route in the first pixel is substantially equivalent to a step difference of a surface of the display panel corresponding to the second liquid crystal dropping route in the second pixel.

5. The method of claim 4, wherein the first pixel and the second pixel respectively comprise a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes the contact hole disposed in the first pixel, then the second liquid crystal dropping route passes the contact disposed in the second pixel.

6. The method of claim 4, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes a portion other than the contact hole in the first pixel, then the second liquid crystal dropping route passes a portion other than the contact hole in the second pixel.

7. The method of claim 4, wherein the plurality of liquid crystal dropping routes are arranged along a row direction or a column direction.

8. The method of claim 1, wherein a plurality of liquid crystal dots are formed along a liquid crystal dropping route of the plurality of liquid crystal dropping routes, and
a diameter of the liquid crystal dot is less than a longest length of one pixel.

9. The method of claim 1, wherein a step difference of a surface of the display panel corresponding to the first liquid crystal dropping route in the first pixel is substantially equivalent to a step difference of a surface of the display panel corresponding to the second liquid crystal dropping route in the second pixel.

10. The method of claim 9, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes the contact hole disposed in the first pixel, then the second liquid crystal dropping route passes the contact disposed in the second pixel.

11. The method of claim 9, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes a portion other than the contact hole in the first pixel, then the second liquid crystal dropping route passes a portion other than the contact hole in the second pixel.

12. A method for manufacturing a liquid crystal display, the method comprising:
preparing two display panels comprising a plurality of pixels arranged in a matrix form; and
dropping liquid crystals along a plurality of liquid crystal dropping routes on one of the two display panels,
wherein a relative position of a first liquid crystal dropping route passing a first pixel among the plurality of pixels with respect to the first pixel, and a relative position of a second liquid crystal dropping route passing a second pixel among the plurality of pixels with respect to the second pixel, are substantially equivalent to each other.

13. The method of claim 12, wherein an edge of the first pixel and an edge of the second pixel corresponding to each other are respectively referred as a first edge and a second edge,
a distance between the first liquid crystal dropping route and the first edge and a distance between the second liquid crystal dropping route and the second edge are substantially equivalent to each other.

14. The method of claim 13, wherein a plurality of liquid crystal dots are formed along a liquid crystal dropping route of the plurality of liquid crystal dropping routes, and
a diameter of the liquid crystal dot is less than a longest length of one pixel.

15. The method of claim 14, wherein a step difference of a surface of the display panel corresponding to the first liquid crystal dropping route in the first pixel is substantially equivalent to a step difference of a surface of the display panel corresponding to the second liquid crystal dropping route in the second pixel.

16. The method of claim 15, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes the contact hole disposed in the first pixel, then the second liquid crystal dropping route passes the contact disposed in the second pixel.

17. The method of claim 15, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes a portion other than the contact hole in the first pixel, then the second liquid crystal dropping route passes a portion other than the contact hole in the second pixel.

18. The method of claim 15, wherein the plurality of liquid crystal dropping routes are arranged along a row direction or a column direction.

19. The method of claim 12, wherein a step difference of a surface of the display panel corresponding to the first liquid crystal dropping route in the first pixel is substantially equivalent to a step difference of a surface of the display panel corresponding to the second liquid crystal dropping route in the second pixel.

20. The method of claim 19, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes the contact hole disposed in the first pixel, then the second liquid crystal dropping route passes the contact disposed in the second pixel.

21. The method of claim 19, wherein the first pixel and the second pixel respectively comprises a first conductive layer disposed on a substrate, an insulation layer disposed on the first conductive layer, and a second conductive layer disposed on the insulation layer,
the insulating layer comprises a plurality of contact holes for contacting between the first conductive layer and the second conductive layer disposed in respective pixels, and
if the first liquid crystal dropping route passes a portion other than the contact hole in the first pixel, then the second liquid crystal dropping route passes a portion other than the contact hole in the second pixel.
